(19) United States
(12) Patent Application Publication
(10) Pub. No.: US 2006/0248024 A1
(43) Pub. Date: Nov. 2, 2006

(54) Price setting system

(76) Inventors: Kenichi Funaki, Tokyo (JP); Yasunori Yamashita, Tokyo (JP); Hiroyuki Konno, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/411,816

(22) Filed: Apr. 27, 2006

(30) Foreign Application Priority Data
Apr. 27, 2005 (JP) 2005-129998

(51) Int. Cl. G06F 17/00; G06G 7/00

(52) U.S. Cl. 705/400

(57) ABSTRACT

Provided is a system which supports appropriate price setting so that a value for a provider in a transaction and a value for a customer reach an agreement. A price setting system stores a provider cost Cp and a return Rc obtained by a customer to calculate a transaction value Vp for the provider and a transaction value Vc for the customer in accordance with an evaluation index (benefit-based, price ratio-based, or ROI-based). Then, the price setting system outputs information that supports the setting of a price P satisfying Vp>0 and Vc>0.

### BACKGROUND OF THE INVENTION

The present invention relates to a price setting system which sets an appropriate price for a product or the like in a transaction between a provider who provides the product or the like and a customer who enjoys a benefit of the product or the like.

Most of conventional price setting methods are based on one of a provider logic and a customer or market logic. For example, cost-plus pricing focuses on the securing of profits of the provider. A method based on a demand curve or price elasticity is on a side of the customer or market logic. A method based on a contribution margin, which is described in “Financial Analysis for Profit-driven Pricing” (G. E. Smith, T. T. Nagle, Sloan Management Review, Spring, 1994), takes both demands and provider's profits into consideration. However, it is still unclear if the pricing reflects a value admitted by each individual customer. A method based on an economic value, and price setting method and system provided by Japanese Patent Laid-Open Publication No. 2001-297178 support price setting based on the value admitted by customers. On the other hand, however, the provider is not guaranteed to secure his/her benefits.

Ideally, it is desirable to realize such a transaction that provides benefit to both the provider who provides a product, service, and technology and the customer who obtains the product, service, and technology. In order to realize such a transaction, the price should be set in view of both the provider logic and the customer logic.

### SUMMARY OF THE INVENTION

The present invention has an object to provide a technique of supporting appropriate price setting so that a value for a provider and a value for a customer in a transaction reach an agreement.

In order to solve the above problem, a price setting system according to the present invention supports appropriate price setting so that the value for the provider and the value for the customer in the transaction reach an agreement.

For example, a first price setting system according to the present invention includes:

storage means which stores a provider cost Cp corresponding to a cost of a provider in a transaction and a customer return Ro corresponding to a return obtained by a customer in the transaction; and

price setting means which sets a price P in the transaction to satisfy Rc>P>Cp

Further, a second price setting system according to the present invention includes:

means which stores a provider cost Cp corresponding to a cost of a provider in a transaction and a customer return Ra corresponding to a return obtained by a customer in the transaction;

price accepting means which accepts a price P in the transaction;

transaction value calculating means which uses the accepted price P to obtain a transaction value Vp for the provider and a transaction value Vc for the customer by using any one of a formula expressed by Vp=P−Cp and Vc=Ra−P, a formula expressed by Vp=(P−Cp)/P and Vc=(Rc−P)/P, and a formula expressed by Vp=(P−Cp)/Cp and Vc=(Rc−P)/P; and

display means which displays the transaction values Vp and Vc obtained by the transaction value calculating means.

The price setting system may include transaction value relation calculating means which uses the provider cost Cp and the customer return Rc to obtain a relation between a transaction value Vp for the provider and a transaction value Vc for the customer by using any one of a formula expressed by Vc=−Vp+Rc−Cp, a formula expressed by Vc=(Rc/Cp) (1-Vp)−1, and a formula expressed by Vc=R/(Cp (1+Vp))−1. The display means may display the relation between the transaction values Vp and Vc obtained by the transaction value relation calculating means and the transaction values Vp and Vc at the price P calculated by the transaction value calculating means.

### BRIEF DESCRIPTION OF THE DRAWINGS

In the accompanying drawings:

FIG. 1 is a diagram for explaining use cases of a price setting system according to an embodiment of the present invention;

FIG. 2 is a schematic configuration diagram of the price setting system;

FIG. 3 is a flowchart of an operation of the price setting system;

FIG. 4 is a diagram for explaining a method of calculating an equilibrium price;

FIG. 5 is a diagram for explaining a method of calculating transaction values;

FIG. 6 is a diagram for explaining a relation between the transaction values;

FIG. 7 is a diagram showing the relation between the transaction values;

FIG. 8 is another diagram showing the relation between transaction values;

FIG. 9 is a further diagram showing the relation between transaction values;

FIG. 10 shows an example of a display screen;

FIG. 11 is a schematic configuration diagram of the price setting system;

FIG. 12 shows an example of a display screen;

FIG. 13 shows another example of the display screen;

FIG. 14 shows a further example of the display screen;

FIG. 15 is a configuration diagram of time-series data of provider costs and customer returns;

FIG. 16 shows a further example of the display screen; and

FIG. 17 is a hardware/software configuration diagram of the price setting system.

### DETAILED DESCRIPTION OF THE PREFERRED EMBODIMENTS

Hereinafter, a price setting system corresponding to an embodiment of the present invention will be described.

The price setting system according to this embodiment sets an appropriate price so that both a provider of a product, service, technology or the like and a customer in a transaction can benefit from the transaction. The price setting system can be used in a business which realizes a benefit of a customer by providing a product, service or technology in accordance with each request of the customer such as system integration service, industrial equipment introduction, installation service or facility establishment.

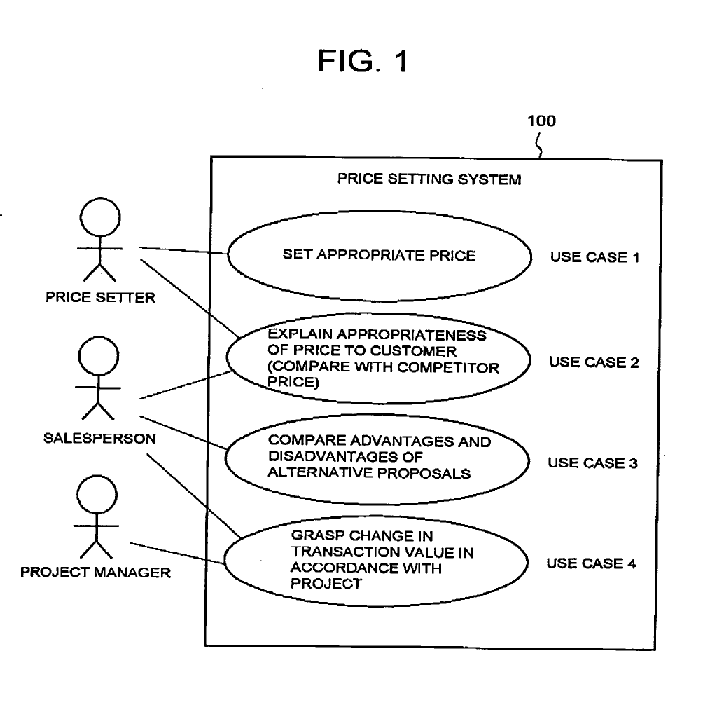

FIG. 1 is a diagram showing use cases of the price setting system according to this embodiment.

As illustrated, the price setting system can be used in a case where a provider sets an appropriate price in advance (use case 1). The price setting system can also be used for presenting appropriateness of a price to a customer through comparison with a proposal of a competitor (use case 2). Moreover, the price setting system can be used for comparing a plurality of alternative proposals (use case 3) or for grasping a change in value of a transaction in accordance with a progress of a project which provides a product, service, or technology. Hereinafter, in accordance with the above-described use cases, the price setting system will be described by way of specific examples.

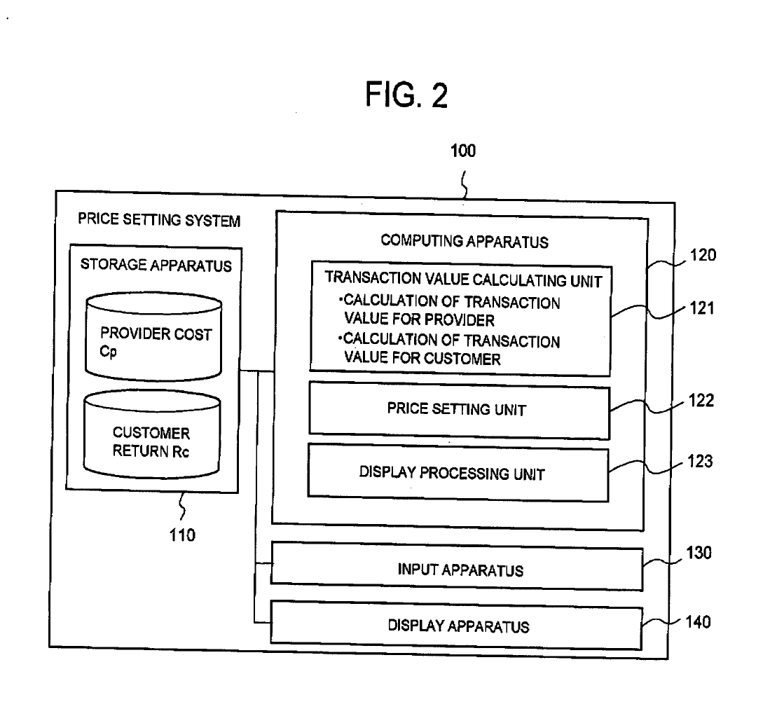

FIG. 2 is a schematic configuration diagram of the price setting system.

A price setting system 100 includes: a storage apparatus 110; a computing apparatus 120; an input apparatus 130; and a display apparatus 140.

The storage apparatus 110 stores a provider cost Cp and a customer return RC.

The provider cost Cp is a cost required for a provider in a transaction to provide a product, service, technology or the like corresponding to an object to be traded. Although the provider cost Cp is basically a cost uniquely calculated for the transaction, the provider cost Cp may also be further classified for each cost item.

The customer return Rc is a return indicating a benefit that a customer can obtain from the transaction. The customer return Rc is basically a quantitatively expressed value such as an amount of money, which is uniquely calculated for the transaction. The customer return Rc may be further classified for each benefit item.

The provider cost Cp and the customer return Rc are input in advance through the input apparatus 130.

The computing apparatus 120 includes; a transaction value calculating unit 121; a price setting unit 122; and a display processing unit 123.

The transaction value calculating unit 121 uses the provider cost Cp and the customer return Rc, which are stored in the storage apparatus 110, and a currently set candidate price P to calculate a value Vp for the provider in the transaction and a value Vc for the customer in the transaction. However, the transaction value differs depending on its evaluation index. Therefore, the transaction value calculating unit 121 uses a calculation formula in accordance with an evaluation index to calculate the transaction value. The storage apparatus 110 stores a program which executes a computational logic in accordance with the evaluation index.

The price setting unit 122 sets a price input from a user via the input apparatus 130 as the candidate price P. However, since it is desirable that both the provider and the customer can get the transaction value, the input value is set as the candidate value P when Rc>P>Cp is satisfied.

The price setting unit 122 sets an “equilibrium price” as the candidate value P in an initial state prior to the input of the candidate price P. In this case, the “equilibrium price” is determined to make the provider value Vp and the customer value Vc equal to each other so that the transaction is equally valuable for both the provider and the customer. Since the “equilibrium price” differs depending on the evaluation index of the transaction value, the price setting unit 122 uses a calculation formula in accordance with the evaluation index to calculate the equilibrium price. The storage apparatus 110 stores a program for executing a computational logic in accordance with the evaluation index.

The display processing unit 123 creates a draw command to transmit the created command to the display apparatus 140, thereby displaying information. For example, the display processing unit 123 collectively displays the relation between the provider value Vp and the customer value Vc on the displays unit 140. The display processing unit 123 also displays information necessary for price setting. The thus displayed information allows the user of the price setting system according to the present invention such as a price setter or a salesperson to set an appropriate price in consideration of the transaction values.

The input apparatus 130 is composed of a keyboard, a mouse and the like to accept an input of information from the user.

The display apparatus 140 is composed of a liquid crystal display or the like to display information in accordance with the draw command from the display processing unit 123.

Next, an operation of the price setting system configured as described above will be described.

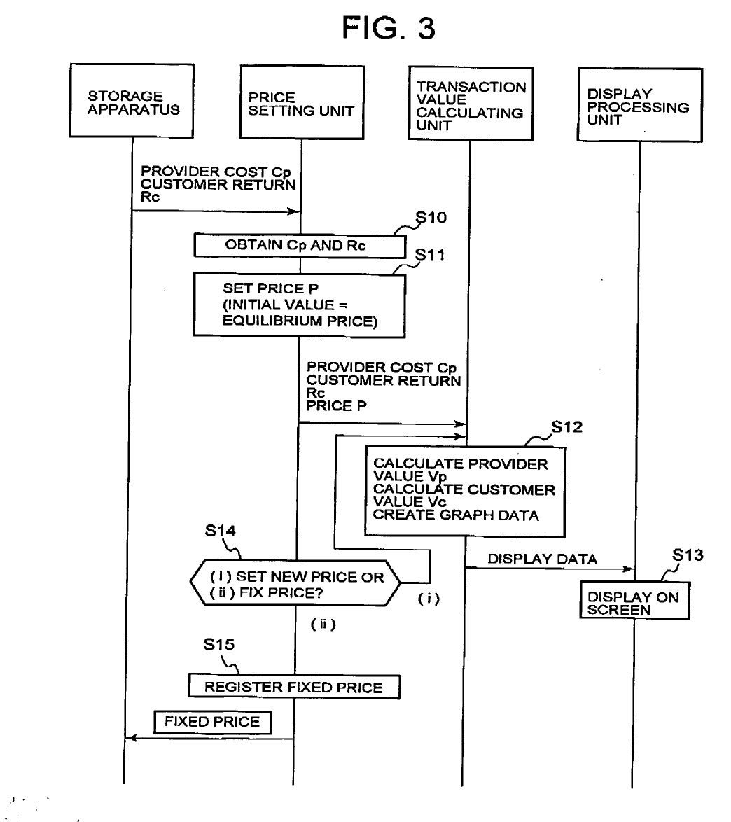

FIG. 3 is a flowchart showing an operation flow or the price setting system 100.

The storage apparatus 110 stores the provider cost Cp and the customer return Rc in advance.

In this embodiment, three modes are provided in accordance with the evaluation index of the transaction value. Specifically, a mode in which the transaction value is evaluated based on the benefit (a benefit-based mode), a mode in which the transaction is evaluated based on a ratio of the benefit to the cost (a price ratio-based mode), and a mode in which the transaction value is evaluated based on are turn on investment (ROI) (an ROI-based mode). The setting of the mode can be changed in response to a request from a user, as described below. Specifically, the price setting unit 122 receives an instruction of mode setting from the user through the input apparatus 130 to set any of the modes in accordance with the received instruction.

First, upon reception of a price setting request from the user through the input apparatus 130, the price setting unit 122 obtains the provider cost Cp and the customer return Rc from the storage apparatus 110 (S10).

Next, the price setting unit 122 sets the candidate price P (S11). In this step, the price setting unit 122 sets the candidate price P to satisfy Rc<P<Cp. Specifically, the price setting unit 122 sets the equilibrium price as the candidate price P. As described above, the equilibrium price is determined to satisfy (the provider value Vp)=(the customer value Vc) so that the transaction is equally valuable for both the provider and the customer.

A method of calculating the equilibrium value differs depending on the evaluation index of the transaction value. In this embodiment, the benefit-based mode, the price ratio-based mode, and the ROI-based mode are provided in accordance with the evaluation index, and a calculation formula in accordance with the set mode is used.

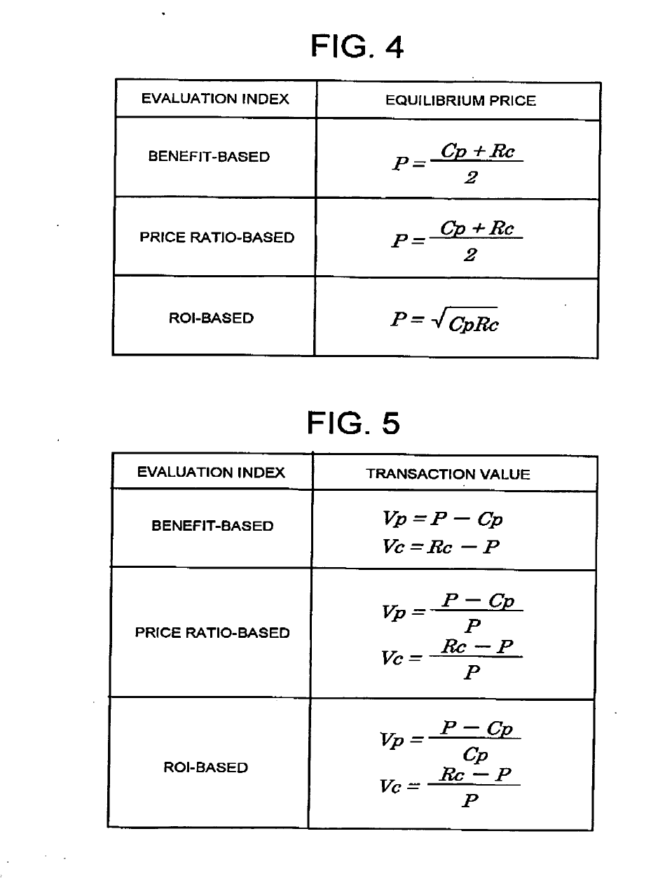

FIG. 4 shows calculation formulae of the equilibrium price in accordance with the evaluation index.

The price setting unit 122 selects a formula for calculating the equilibrium price in accordance with the evaluation index of the set mode and uses the selected formula to calculate the equilibrium price.

For example, a case where the provider cost Cp=50000 yen and the price return Rc=100000 yen is considered. When the benefit-based mode is set, the equilibrium price is obtained as P=(Cp+Rc)/2=75000 yen. When the ROI-based mode is set, the equilibrium price is obtained as P=√(CpRC)=70711 yen.

The evaluation index of the transaction value and the calculation formula of the equilibrium price may be different from those shown in FIG. 4.

Next, the transaction value calculating unit 121 uses the provider cost Cp, the customer return Rc, and the candidate price P obtained by the price setting unit 122 to calculate the value Vp for the provider and the value Vc for the customer in the transaction (S12).

A method which calculates each of the transaction values differs depending on the evaluation index. FIG. 5 shows calculation formulae of the transaction value in accordance with the evaluation index. The transaction value calculating unit 121 selects the calculation formula of the transaction value in accordance with the evaluation index of the set mode and uses the selected formula to obtain a transaction value.

For example, the provider cost Cp=50000 yen and the customer return Rc=100000 yen are established, and the candidate price P is set to 80000 yen.

When the benefit-based mode is set, the provider value Vp=P−Cp=30000 yen and the customer value Vc=Rc−P=20000 yen are obtained. When the price ratio-based mode is set, the provider value Vp=(P−Cp)/P=0.375 and the customer value Vc=(Rc−P)/P=0.25 are obtained. When the ROI-based mode is set, the provider value Vp=(P−Cp)/Cp=0.6 and the customer value Vc=(Rc−P)/P=0.25 are obtained.

The evaluation index of the transaction value and the calculation formula of the transaction value may be different from those shown in FIG. 5.

When the transaction values Vp and Vc at the price P are obtained in this manner, the display processing unit 123 displays the obtained transaction values Vp and Vc on the display apparatus 140. Furthermore, the display processing unit 123 also displays a graph showing the relation between the transaction values Vp and Vc to support the price setting (S13).

The relation between the transaction values Vp and Vc will now be described.

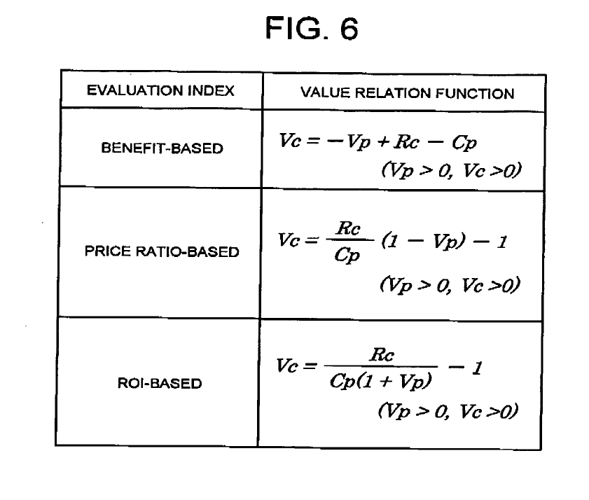

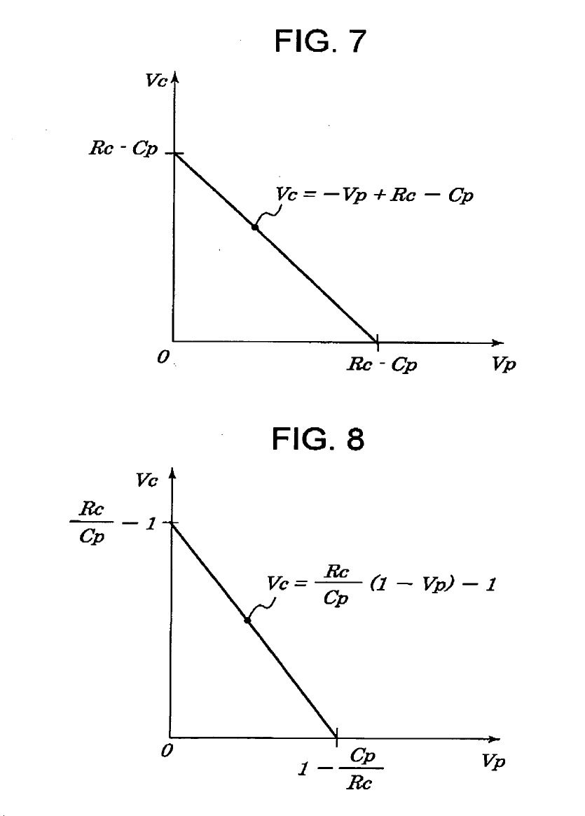

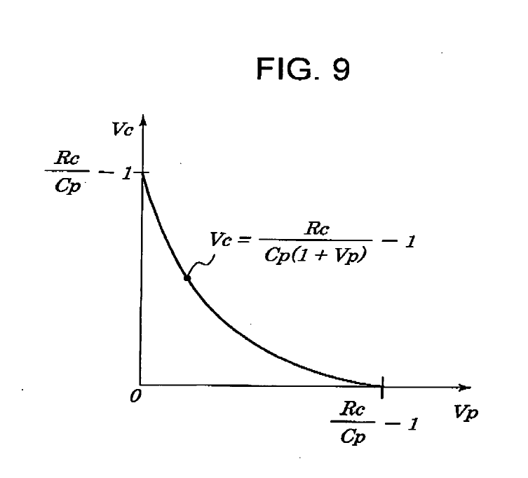

The relation between the provider value Vp and the customer value Vc differs depending on the evaluation index of the transaction value. Specifically, the relation between the provider value Vp and the customer value Vc is expressed by function formulae shown in FIG. 6 in accordance with the respective evaluation indices of the benefit-based mode, the price ratio-based mode, and the ROI-based mode. The relations are shown in graphs in FIG. 7 (the benefit-based mode), FIG. 8 (the price ratio-based mode), and FIG. 9 (the ROI-based mode), respectively.

Based on the relations as described above, the display processing unit 123 shows the relation between the provider value Vp and the customer value Vc as a graph which indicates the values Vp and Vc on two axes in accordance with the evaluation index of the set mode.

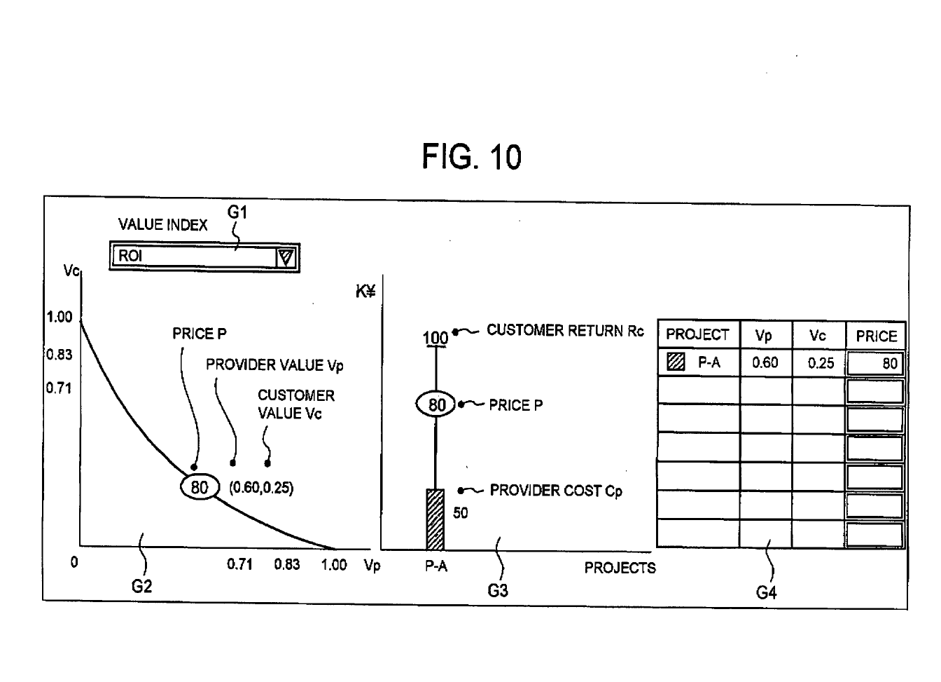

FIG. 10 shows an example of a display screen.

In FIG. 10, a list box G1 serves to accept the selection of a mode in accordance with the evaluation index of the transaction value. The price setting unit 122 sets the mode based on the evaluation index selected in the list box G1.

A graph G2 shows the relation between the provider value Vp and the customer value Vc with the evaluation index of the set mode. In the graph G2, the provider value Vp is indicated on the abscissa axis, whereas the customer value Vc is indicated on the ordinate axis.

On the graph G2, the provider value Vp and the customer value Vc at the currently set candidate price P are also displayed.

A graph G3 shows the relation between the provider cost Cp, the customer return Rc, and the price P. The graph G3 shows a positional relation between the provider cost Cp and the customer return Rc in the transaction, and the currently set candidate price P.

The display processing unit 123 displays a table G4 which enumerates the provider values Vp, the customer values Cp, and the prices P.

The display processing unit 123 displays the graphs G2 and G3 and the table G4 so that their display contents are linked to each other. Specifically, the provider value Vp, the customer value Vc and the currently set price P are common to the graphs G2 and G3 and the table G4.

Returning to the flowchart of FIG. 3, the description will be continued. As described above, during the display of the graphs G2 and G3 and the table G4, the price setting unit 122 accepts (i) a modification request of the candidate price P or (ii) a fixing request of the price, from the user through the input apparatus 130. The price setting unit 122 accepts the selection of a new candidate price in the range between the displayed provider cost Cp and the displayed customer return Rc. If the candidate price P is selected out of the above range, the price setting unit 122 may issue an alert or the like not to accept the selection (S14) Alternatively, the price setting unit 122 may issue an alert or the like not to accept the modification request of the candidate price P when the provider value Vp and the customer value Vc at the candidate price P are calculated in accordance with the evaluation index not to satisfy both Vp>0 and Vc>0.

If the price setting unit 122 accepts the modification request of the candidate price P ((i) in S14), the price setting unit 122 resets the accepted value as the candidate price P. Then, a subsequent process is restarted from S12. Specifically, the transaction value calculating unit 120 uses the new candidate price P to obtain the provider value Vp and the customer value Vc (S12) Then, the display processing unit 123 displays the newly set candidate price P and the newly obtained provider value Vp and customer value Vc on the display 130 (S13).

On the other hand, if the price setting unit 122 accepts the price fixing request ((ii) in S14), the price setting unit 122 registers the currently set candidate price P as a fixed price in the storage apparatus 110 (S15) and then terminates the process.

The embodiment of the present invention (the use case 1 in FIG. 1) has been described above.

According to the above-described embodiment, appropriate price setting in the transaction can be supported.

Next, the case where the price is set in view of a product of a competitor or the like (the use case 2 in FIG. 1) will be described.

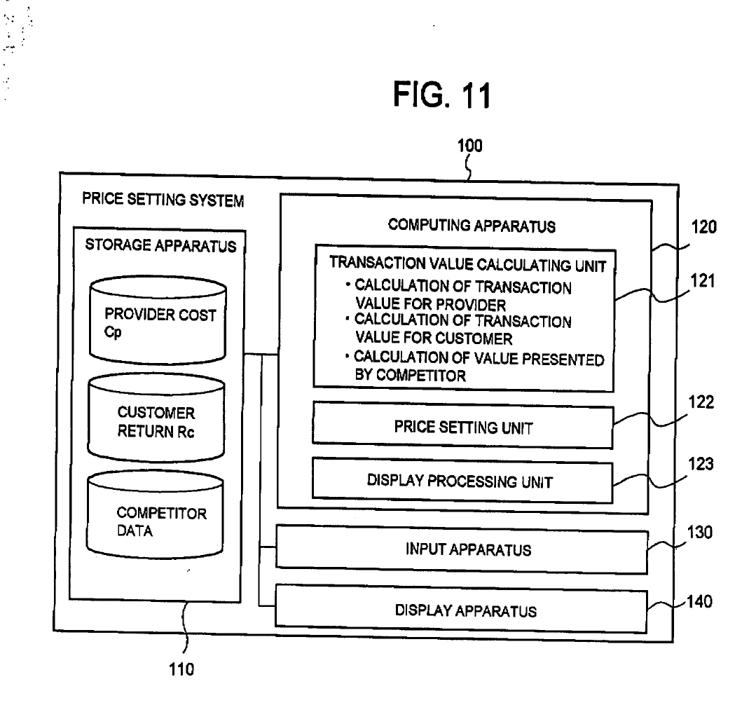

FIG. 11 is a schematic configuration diagram of the price setting system in the above-mentioned case. In comparison with the configuration of the price setting system shown in FIG. 2, the storage apparatus 110 further stores competitor data containing a competitor return Rc′ and a competitor price P′. The competitor return Rc′ is a return that the customer can obtain from the proposal of a competitor The competitor price P′ is a price that is presented by a competitor.

Although the transaction value calculating unit 121 basically performs the above-described process, the transaction value calculating unit 121 further calculates a value Vc′ provided by the competitor by using the competitor return Rc′ and the competitor price P′.

For example, a case where the customer return Rc′ based on the proposal of the competitor=120000 yen and the price PI presented by the competitor=90000 yen will be considered. When the benefit-based mode is set, the value Vc′ provided by the competitor=300000 yen is obtained by a calculation formula Vc′−Rc′−P′. When the price ratio-based mode or the ROI-based mode is set, Vc′ 0.33 is obtained by the calculation formula Vc′=(Rc′−P′)/P.

Upon acceptance of the candidate price P (S14), the price setting unit 122 sets the accepted price as the candidate price P when the price satisfying Vp>0 and Vc>Vc′ is accepted. In this case, the transaction value calculating unit 121 calculates Vp, Vc and Vc′ based on the input price.

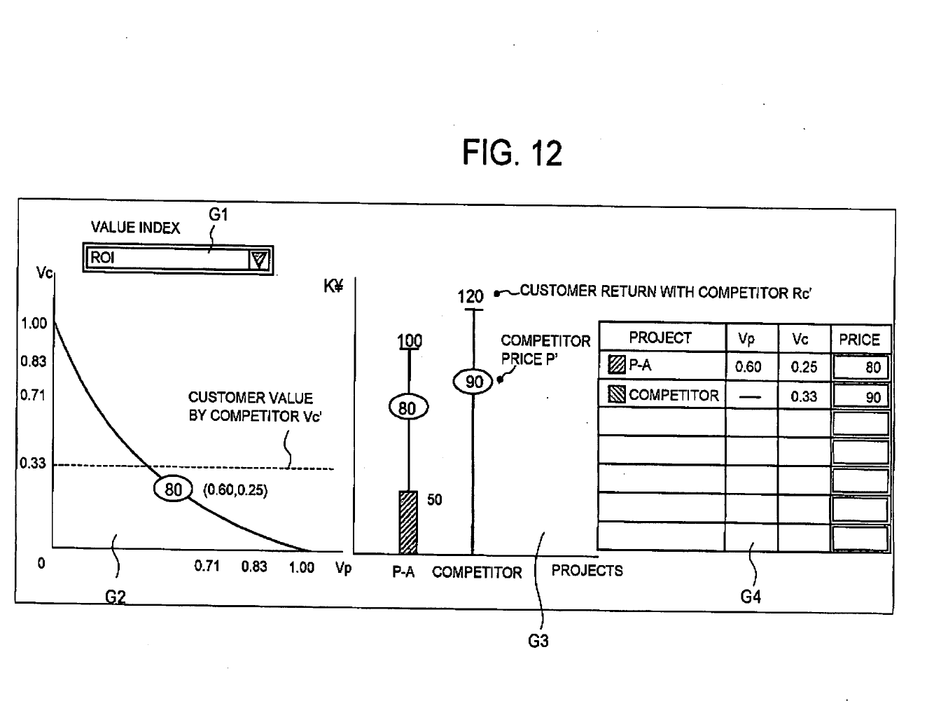

The display processing unit 123 displays, for example, as illustrated in FIG. 12, the value Vc′ presented by the competitor over the graph G2 shown in FIG. 10 for reference to a proposal of the competitor. The display processing unit 123 also displays the competitor price P′ and its customer return Rc′ on the graph G3.

The graph G2 allows the user to know whether or not the currently set candidate price P is less advantageous than the proposal of the competitor. In the example shown in FIG. 12, it is found that the candidate price P (80000 yen) currently set by the user is less advantageous than the proposal of the competitor. By an evaluation with, for example, the ROI-based evaluation index, it is found that the candidate price P is required to be lowered to less than 75000 yen.

Next, description will be made of a case where a plurality of alternative proposals are provided for a product, service, technology, or the like that can be provided by the provider in a transaction, and the provider value Vp and the customer value Vc in the transaction are compared with each other for each of the alternative proposals (the use case 3 in FIG. 1).

In such a case, the storage apparatus 110 stores the provider cost Cp for each alternative proposal and the customer return Rc for each alternative proposal.

The price setting unit 122 sets the candidate price P for each alternative proposal. Specifically, upon acceptance of the candidate price P from the user (S14), the price setting unit 122 accepts the candidate price P for each alternative proposal.

The transaction value calculating unit 121 calculates the provider value Vp and the customer value Vc at the candidate price P in each alternative proposal.

For display, the display processing unit 123 obtains the relation between the provider value Vp and the customer value Vc for each alternative proposal to display a graph showing the obtained relation.

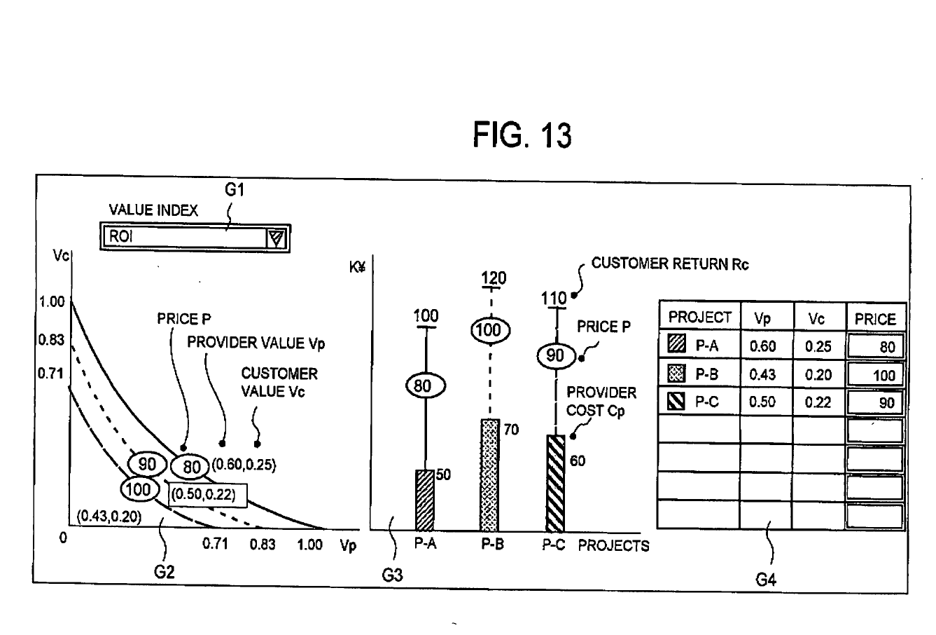

For example, the display processing unit 123 displays the relation between the provider value Vp and the customer value Vc as a graph for each alternative proposal as shown in FIG. 13 and further displays the provider value Vp and the customer value Vc at the candidate price P, for each alternative proposal.

In addition, the display processing unit 123 also displays the graph G3 showing the relation between the provider cost Cp, the customer return Rc, and the set candidate price P for each alternative proposal.

The display screen allows the user to compare the advantages and disadvantages of the alternative proposals with each other. At the same time, the user can use the display screen to persuade the customer for the proposal of a price.

Next, the case where the provider cost or the customer return fluctuates to change the provider value or the customer value in the transaction will be described (the use case 4 in FIG. 1).

In an actual transaction, the supply of a product, service, or technology to the customer is often achieved as a project. In such a case, even after the transaction is established and the price is determined, the provider cost and the customer return may fluctuate depending on the status of progress of the project. Accordingly, it is considered that the provider value or the customer value in the transaction correspondingly changes.

Therefore, an embodiment in which the user such as a salesperson or a project manager can grasp how the provider value Vp and the customer value Vc change in accordance with the progress of the project will be described.

In such a case, in order to grasp the transaction values in accordance with the progress of the project, the storage apparatus 110 stores the provider cost and the customer return at each progress management time of the project for the transaction.

The transaction value calculating unit 121 calculates the provider value Vp and the customer value Vc at each progress management time.

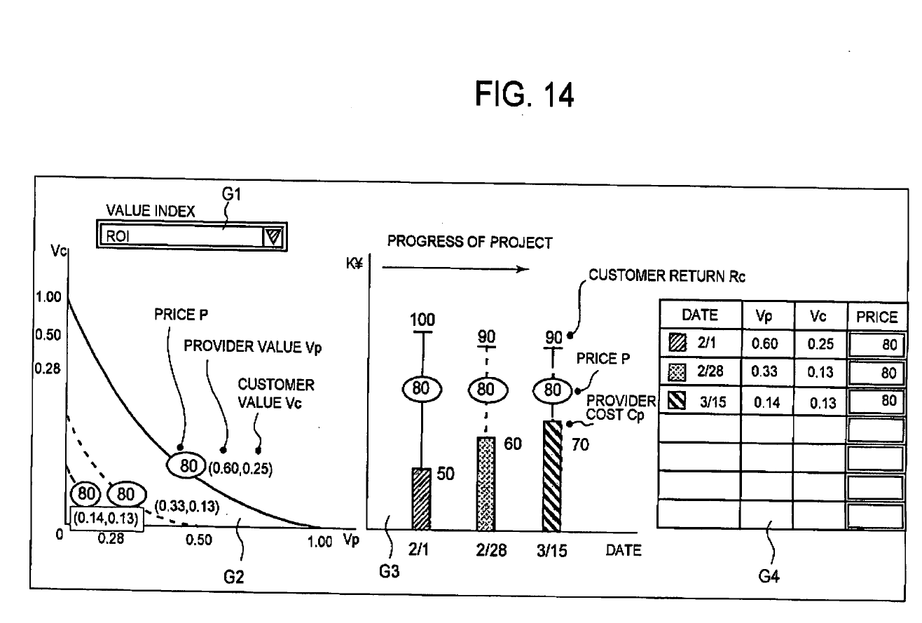

The display processing unit 123 obtains and displays the relation between the provider value Vp and the customer value Vc at each progress management time. For example, as shown in FIG. 14, the display processing unit 123 displays a screen that allows the collective grasp of the provider value Vp, the customer value Vc and the price P at each progress management time.

This screen allows a transition of the provider value or the customer value along with the progress of the project to be grasped. In some cases, the screen serves to examine the resetting of a price or the review of a project system.

The present invention is also applicable to the consideration of a time value of the provider cost or the customer return for calculating the provider value or the customer value in the transaction.

In an actual transaction, for providing a product, service or technology, the project sometimes becomes a long-term one, for example, as in the case of material or facility procurement, securing of human resources, product manufacture, system integration, delivery to a customer site, installation work, or the like. In such a case, it is considered that a time value of money had better be taken into consideration to set the price.

In the above-described case, the storage apparatus 110 stores provider cost data in the transaction as a set of costs, each being accrued at each time point on a time line. The storage apparatus 110 also stores customer return data as a set of returns, each being obtained at each time point on the time line.

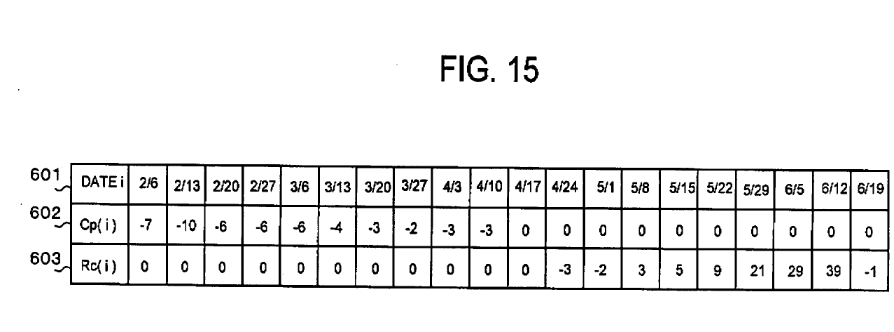

FIG. 15 shows a configuration of data stored in the storage apparatus 110 at each time point on the time line. As illustrated, at each time point 601 on the time line, the data contains a provider cost 602 and a customer return 603.

In order to use such data to calculate the provider value Vp and the customer value Vc, the provider cost Cp and the customer return Rc are required to be converted into current values by using a discount rate r. The candidate price P is also required to be converted into a current value to be obtained as a current value converted price Pp. The obtained provider cost Cp, customer return Rc, and current value converted price Pp are expressed as Formulae A, B, and C, respectively.
Formula 1

$$\begin{matrix}Cp = {\sum }_{i} \frac{Cp ( i )}{{( 1 + r )}^{i}} & Formula A \\ Rc = {\sum }_{i} \frac{Rc ( i )}{{( 1 + r )}^{i}} & Formula B \\ Pp = \frac{P}{{( 1 + r )}^{s}} & Formula C\end{matrix}$$

where i is a time point (currently, i=0), s is a time point of payment of the transaction, r is a discount rate, Cp(i) is the provider cost accrued at the time point i, and Rc(i) is the customer return obtained at the time point i.

The transaction value calculating unit 121 uses the provider cost Cp, the customer return Rc and the current value converted price Pp obtained in the above-described manner to calculate the provider value Vp and the customer value Vc.

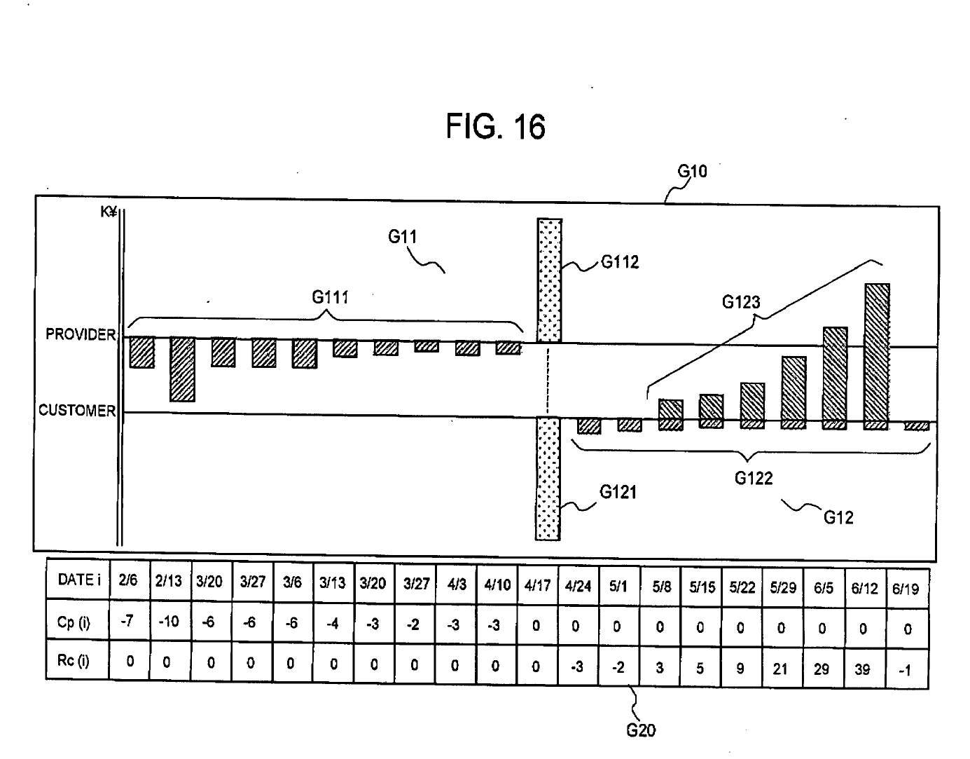

For easy grasp of a cash flow on the time line by the transaction, the display processing unit 123 displays a graph G10 as shown in FIG. 16 together with a table G20 in the cash flow. In FIG. 16, the graph G10 is composed of a provider cash flow G11 and a customer cash flow G12. The provider cash flow G11 shows a cost G111 and a price P (order price) G112 at each time point. The customer cash flow G12 shows a price P (order price) G121 and returns G122 and G123 at each time point. The price P (order price) G112 and the price P (order price) G121 are the same.

FIG. 16 shows the case where the time of payment is in the week of April 17. As a cash flow at the time of payment, FIG. 16 shows that the provider has an income corresponding to the price whereas the customer has an expense corresponding to the price.

The embodiments of the present invention have been described above.

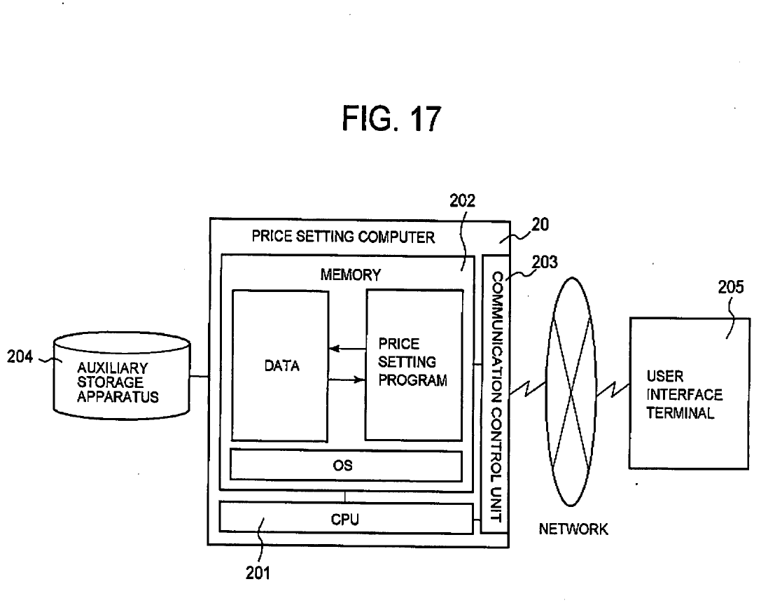

FIG. 17 shows an example of a hardware/software configuration for realizing the price setting system according to the present invention.

A price setting computer 20 that implements the price setting system 100, includes: a CPU (Central Processing Unit) 201 that executes various operations and instructions necessary for system operation; a memory 202 that stores an OS (Operating System), application programs such as a price setting program that describes the contents of operation of the price setting system, and data necessary for the programs; and a communication control unit 203 that controls the connection or the communication with the exterior through a network as needed.

The connection of an auxiliary storage apparatus 204 to the price setting computer 20 allows the auxiliary storage apparatus 204 to store the OS, the programs and the data to be stored in the memory 202.

A user interface that allows the user to operate the price setting system or to input/output data can be provided in the price setting computer 20. However, in order to allow a user access from a location physically distant from the price setting computer 20, a user interface terminal 205 is provided externally to the price setting computer 20 to be connected to the price setting computer 20 through the communication control unit 203 of the price setting computer 20 and a network as illustrated, thereby enabling the communication with the price setting computer 20.

In the above-described hardware/software configuration, each of the functional units of the price setting system 100 shown in FIG. 2 or FIG. 11 corresponds to each of the components in FIG. 17 in the following manner.

The function of the storage apparatus 110 is mainly realized by the memory 202. On the other hand, for the storage of an enormous amount of data or the storage in a fixed manner, the function of the storage apparatus 110 is realized by the auxiliary storage apparatus 204.

Each of the functions of the transaction value calculation unit 121, the price setting unit 122 and the display processing unit 123 is realized by the interaction between the OS or the price setting programs stored in the memory 202 and the CPU 201 that controls the OS and the price setting programs. At this time, various data stored in the memory 202 or the auxiliary storage apparatus 204 are referred to or updated. When the transaction value calculating unit 121, the price setting unit 122 and the display processing unit 123 require the communication with the user interface terminal 205, the communication control unit 203 realizes the functions of the transaction value calculation unit 121, the price setting unit 122 and the display processing unit 123.

In the above description of the embodiments, the price setting in businesses that provide a product, service, or technology in accordance with each request of a customer to realize the benefits of the customer, such as system integration service, industrial equipment introduction, installation service, and facility establishment, is assumed. However, it is apparent that the application or the present invention is not limited to the above-described businesses; the present invention is also widely applicable without limiting the businesses to which the present invention is applied when a price is set in consideration of both the value for a provider and the value for each customer in the transaction.

The price setting system according to the present invention allows both the provider value and the customer value in the transaction to be taken into consideration in the transaction between the provider who provides a product, service or technology and the customer who obtains the product, service or technology to set a price that can satisfy both the provider and the customer

What is claimed is:

1. A price setting system, comprising:
storage means which stores a provider cost Cp corresponding to a cost of a provider in a transaction and a customer return Rc corresponding to a return obtained by a customer in the transaction; and
price setting means which sets a price P in the transaction to satisfy Rc>P>Cp.

2. A price setting system according to claim 1, wherein the price setting means sets the price P by using one of a calculation formula expressed by P=(Cp+Rc)/2 and a calculation formula expressed by
P=\sqrt{CpRc}. Formula 1

3. A price setting system, comprising:
means which stores a provider cost Cp corresponding to a cost of a provider in a transaction and a customer return Rc corresponding to a return obtained by a customer in the transaction;
price accepting means which accepts a price P in the transaction;
transaction value calculating means which uses the accepted price P to obtain a transaction value Vp for the provider and a transaction value Vc for the customer by using any one of a formula expressed by Vp=P−Cp and Vc=Ra−P, a formula expressed by Vp=(P−Cp)/P and Vc=(Rc−P)/P, and a formula expressed by Vp=(P−Cp)/Cp and Vc=(Pc−P)/P; and
display means which displays the transaction values Vp and Vc obtained by the transaction value calculating means.

4. A price setting system according to claim 3, wherein:
the storage means further stores a competitor return Rc′ corresponding to a return obtained by the customer in a transaction provided by a competitor of the transaction and a competitor price P′ corresponding to a price presented by the competitor;
the transaction value calculating means obtains a customer value Vc′ by the competitor by using one of a formula expressed by Vc′=Ra′−P′ and a formula expressed by Vc′=(Rc′−P′)/P′; and
the display means displays the transaction values Vp and Vc with the customer value Vc′ by the competitor.

5. A price setting system according to claim 3, wherein:
the storage means stores the provider cost Cp and the customer return Ra for each alternative proposal of the transaction;
the price accepting means accepts the price P for each alternative proposal;
the transaction value calculating means calculates the transaction values Vp and Vc at the price P in the alternative 9 proposal for each alternative proposal; and
the display means displays the transaction values Vp and Vc for each alternative proposal.

6. A price setting system according to claim 3, wherein:
the storage means stores the provider cost Cp and the customer returns Rc in accordance with progress of a project;
the transaction value calculating means calculates the transaction values Vp and Vc in accordance with the progress of the project; and
the display means displays the transaction values Vp and Vc in accordance with the progress of the project.

7. A price setting system according to claim 3, wherein:
the storage means stores the provider cost Cp as a set of costs, each being accrued at each time point on a time line and the customer return Rc as a set of returns, each being obtained at each time point on the time line; and
the transaction value calculating means uses the provider cost Cp and the customer return Rc, each being converted into a value at the same time point, to obtain the transaction values Vp and Vc.

8. A price setting system, comprising:
storage means which stores a provider cost Cp corresponding to a cost of a provider in a transaction and a customer return Rc corresponding to a return obtained by a customer in the transaction;
transaction value relation calculating means which uses the provider cost Cp and the customer return Rc to obtain a relation between a transaction value Vp for the provider and a transaction value Vc for the customer by using any one of a formula expressed by Vc=−Vp+Rc−Cp, a formula expressed by Vc=(Rc/Cp) (1−Vp)−1, and a formula expressed by Vc=Ac/(Cp (1+Vp))−1;
price accepting means which accepts the price P in the transaction:
transaction value calculating means which uses the accepted value P to calculate the transaction value Vp for the provider and the transaction value Vc for the customer by using any one of a formula expressed by Vp=P−Cp and Vc=Rc−P, a formula expressed by Vp=(P−Cp)/P and Vc=(Rc−P)/P, and a formula expressed by Vp=(P−Cp)/Cp and Vc=(Rc−P)/P; and
display means which displays the relation between the transaction values Vp and Vc obtained by the transaction value relation calculating means and the transaction values Vp and Vc at the price P calculated by the transaction value calculating means.

9. A price setting system according to claim 8, wherein:
the storage means further stores a competitor return Rc′ corresponding to a return obtained by the customer in a transaction provided by a competitor of the transaction and a competitor price P′ corresponding to a price presented by the competitor;
the transaction value calculating means obtains a customer value Vc′ by the competitor by using one of a formula expressed by Vc′=Rc′−P′ and a formula expressed by Vc′=(Rc′−P′)/P′; and
the display means displays the transaction values Vp and Vc with the customer value Vc′ by the competitor.

10. A price setting system according to claim 8, wherein:
the storage means stores the provider cost Cp and the customer return Rc for each alternative proposal of the transaction;
the price accepting means accepts the price P for each alternative proposal;
the transaction value relation calculating means calculates the relation between the transaction values Vp and Vc for each alternative proposal;
the transaction value calculating means calculates the transaction values Vp and Vc at the price P in the alternative proposal for each alternative proposal; and
the display means displays the relation between the transaction values Vp and Vc and the transaction values Vp and Vc at the price P in each alternative proposal.

11. A price setting system according to claim 8, wherein:
the storage means stores the provider cost Cp and the customer return Rc in accordance with progress of a project;
the transaction value relation calculating means calculates the relation between the transaction values Vp and Vc in accordance with the progress of the project;
the transaction value calculating means calculates the transaction values Vp and Vc at the price P in accordance with the progress of the project; and
the display means displays the relation between the transaction values Vp and Vc in accordance with the progress of the project and the transaction values Vp and Vc at the price P.

12. A price setting system according to claim 8, wherein:
the storage means stores the provider cost Cp as a set of costs, each being accrued at each time point on a time line, and the customer return Rc as a set of returns, each being obtained at each time point on the time line;
the transaction value relation calculating means uses the provider cost Cp and the customer return Rc, each being converted into a value at the same time point, to calculate the relation between the transaction values Vp and Vc; and
the transaction value calculating means uses the provider cost Cp and the customer return Rc, each being converted into a value at the same time point, to calculate the transaction values Vp and Vc.
